(19) United States
(12) Patent Application Publication
(10) Pub. No.: US 2006/0177101 A1
(43) Pub. Date: Aug. 10, 2006

(54) Self-locating device and program for executing self-locating method

(75) Inventors: Masahiro Kato, Tokyo (JP); Takeshi Kato, Akishima (JP)

Correspondence Address: Stanley P. Fisher;Reed Smith LLP, Suite 1400, 3110 Fairview Park, Falls Church, VA, 22042-4503, US

(73) Assignee: Hitachi, Ltd.

(21) Appl. No.: 11/285,354

(22) Filed: Nov. 23, 2005

(30) Foreign Application Priority Data
Feb. 10, 2005 (JP) 2005-033772

(51) Int. Cl. G01C 3/00; G06K 9/00

(52) U.S. Cl. 382/106; 356/3

(57) ABSTRACT

A self-locating device that captures omni-directional camera images and determines its position and posture from the sensed images is disclosed. Omni-directional predicted images of a robot in a supposed moved position from an initial position are generated from omni-directional camera images that can be acquired when the robot is arranged in the initial position, and these predicted images and omni-directional images newly acquired when the robot has actually moved are matched with each other to detect the robot position and posture (direction).

### CLAIM OF PRIORITY

The present application claims priority from Japanese application JP 2005-033772 filed on Feb. 10, 2005, the content of which is hereby incorporated by reference into this application.

### FIELD OF THE INVENTION

The present invention relates to a self-locating method and device for taking omni-directional camera images and finding the position and posture of the device.

### BACKGROUND OF THE INVENTION

A self-locating means intended for measuring the position of a apparatus is an indispensable constituent element of an autonomous mobile robot system. Supposing that such a robot is used within a building or in a space surrounded by shields, a method by which the robot locates itself according to markers within the field of view around would prove more useful than a configuration using the Global Positioning System (GPS) which is readily obstructed by shielding bodies.

Typical methods of self-location using markers within the field of view around, for instance plural landmarks found around a mobile body, such as a autonomous mobile robot, are sensed with an omni-directional camera installed on the mobile body to measure the mobile body's own position and direction (for example, see JP-A No. 337887/2000).

There also is a technique by which, where a specific purpose such as charging the battery of a mobile body can be achieved by guiding the mobile body to a prescribed position, the relative distance between the prescribed position and the mobile body's own position is measured (for example, see JP-A No. 303137/2004).

Or, where prescribed markers installed above a mobile body, such as ceiling fluorescent lights, are given in advance as landmarks on the guidance course map for the mobile body, the guiding purpose may be achieved by detecting the prescribed markers, such as ceiling fluorescent lights, and matching them with the guidance course map.

The conventional methods described above presuppose that the prescribed landmarks that can be detected from around the mobile body to measure the mobile body's own position are distinguishable. In the technique described in Patent Document 1 for instance, specific signs such as “+”, “−”, “//” and “=” are added to the landmarks. Therefore, if the prescribed landmarks fail to be detected or, even if detected, individual landmarks cannot be distinguished from one another, self-locating will be impossible.

Or where a mobile body memorizes a planned guidance course and landmarks, such as ceiling fluorescent lights, installed on the guidance course, it can distinguish landmarks on the course by matching newly detected landmarks and the memorized landmarks while following the memorized moving course, but this method requires advance storing of the guidance course and the landmarks arranged on the guidance course.

Therefore a need exists to self-locate a mobile body using sensed images and comparing the sensed images to known images in order to predict the position of the mobile body.

### SUMMARY OF THE INVENTION

Aspects of the present invention disclosed in this application are summarized below:

a self-locating device having an image sensor for acquiring omni-directional camera images, further comprising a recording part for recording predicted images expected to be sensed in each of plural arrangement positions via the image sensor, each matched with one or another of the plural arrangement positions; and a self-located position measurement part for matching sensed images with the plural predicted images and thereby acquiring the device's own position and posture; and

a program for realizing the self-located position measurement part.

The invasion of a person or the like into the view makes possible identification of the device's own position and direction without having to recognize any specific marker.

### BRIEF DESCRIPTION OF THE DRAWINGS

Understanding of the present invention will be facilitated by consideration of the following detailed description of the preferred embodiments of the present invention taken in conjunction with the accompanying drawings, in which like numerals refer to like parts:

FIG. 1 illustrates the mode in which a self-locating process may be implemented according to an aspect of the present invention;

FIG. 2 comprises flow charts showing the flows of an initialization process and a self-locating process;

FIG. 3 illustrates an embodiment of the self-locating technique;

FIG. 4 is a flow chart of processing by a feature extraction part;

FIG. 5 illustrates the principle of measuring a distance from a camera to a marker with a wavelet transform part;

FIG. 6 illustrates a case of applying a self-locating device to ceiling-walking robots;

FIG. 7 shows an overhead view with one robot installed at a coordinate S in the robot's walking area;

FIG. 8 shows one embodiment of system configuration of an autonomous mobile robot equipped with a self-locating device;

FIG. 9 shows one example of control command transmitted from a navigation part to a control part;

FIG. 10 shows how a robot travels on a circular track under self regulation;

FIG. 11 shows the configuration of a case in which an initialization process flow and a self-locating process flow are sequentially implemented;

FIG. 12 shows the configuration of a case in which an initialization process flow and a self-locating process flow are implemented in parallel;

FIG. 13 shows the configuration of an embodiment in which a feature extraction part is applied to the configuration in FIG. 11; and

FIG. 14 shows the configuration of an embodiment in which a feature extraction part is applied to the configuration in FIG. 12.

### DETAILED DESCRIPTION

It is to be understood that the figures and descriptions of the present invention have been simplified to illustrate elements that are relevant for a clear understanding of the present invention, while eliminating, for the purpose of clarity, many other elements found in a self-locating device and method. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

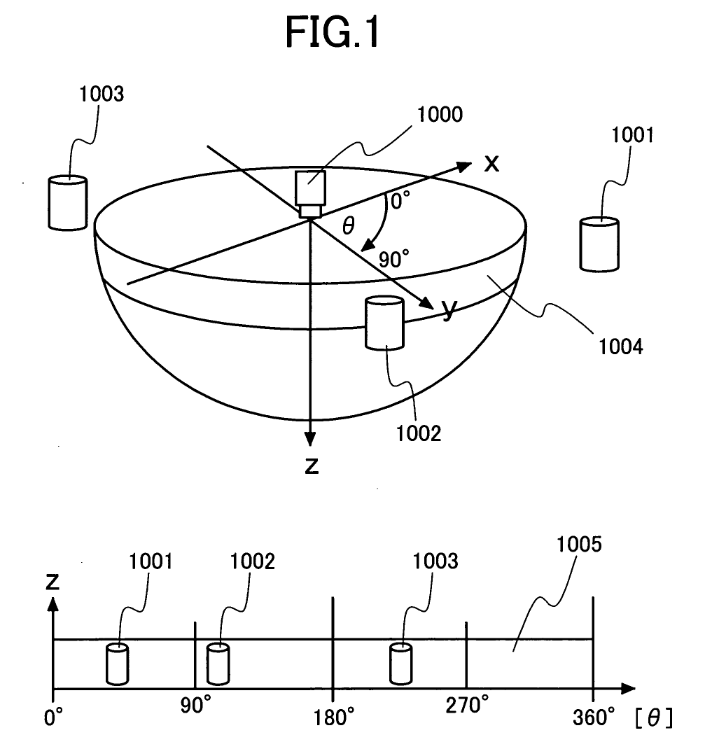

FIG. 1 illustrates the mode in which a self-locating process may be implemented according to an aspect of the present invention

FIG. 1 shows a state in which a wide-angle camera 1000 of 180 degrees in viewing angle is in its initial position and the camera 1000 is so fixed that its optical axis is directed perpendicularly downward. Incidentally, though the viewing angle is supposed to be 180 degrees in this embodiment, any angle that can be deemed to be in a substantially horizontal direction is acceptable. More specifically, a range of 180±60 degrees is supposed. A strip-shaped area orthogonal to the optical axis in the field of view of the camera 1000 is denoted by 1004, and the wide-angle camera 1000 is supposed to photograph this area. Further, three markers 1001 through 1003 of the same shape are installed around the camera 1000, and a coordinate system x-y-z having the center of the camera as its origin is shown in this diagram. In this coordinate system, definitions are given as set forth in FIG. 1 with the direction of the rotation angle θ around the axis from the x axis toward the y axis being supposed to be forward.

Out of an image taken under these conditions, developing the strip-shaped area 1004 on a plane would result in the shape denoted by 1005. The horizontal axis of this image represents the rotation angle θ and the vertical axis, the coordinate on the z-axis. In the coordinate system defined in this way, the markers 1001 through 1003 should be arranged so that the strip-shaped image 1005 taken by the camera 1000 having moved to any desired position on the x-y coordinates and taking any desired posture prove to be a unique image that cannot be taken in any other position and posture. Therefore, by arranging at least markers in asymmetrical positions around the origin of coordinates, a broad area satisfying the conditions stated above can be demarcated. Further, where omni-directional camera images taken indoors in a common home or office are to be processed, since the pattern arrangement of furniture, windows, pillars and so forth contained in these images is usually asymmetrical, no particular care need to be taken about making the arrangement asymmetrical where these patterns are used as markers.

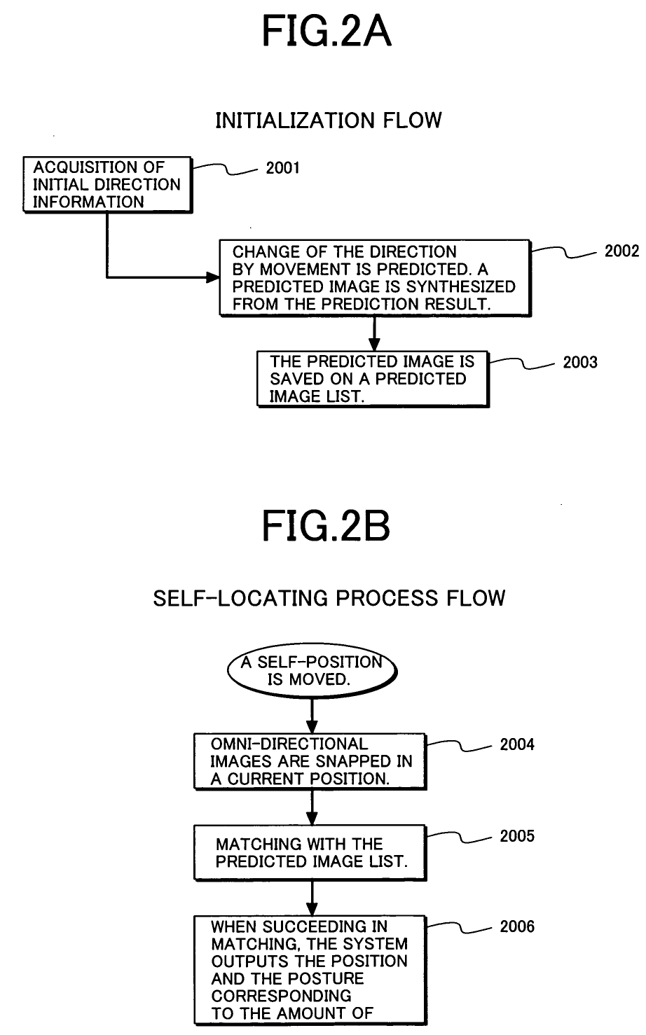

FIG. 2 comprises flow charts illustrating the self-locating procedure. The flow illustrated includes two independent flows, an initialization process from steps 2001 through 2003 and a self-locating process from step 2004 through 2006. To implement these two processes, a robot (camera) is arranged in its initial position, subjected to the initialization process once, and then the self-locating process can be implemented while moving the position of the robot (camera). Alternatively, another camera can be fixed in its initial position, followed by the initialization process, and the self-locating process can be implemented at the same time in parallel while moving the robot's own position. This method of implementation enables the robot, even if another robot or a person enters the environment in which self-locating is to be carried out and the lighting condition and other factors are thereby changed to vary the initial image, to measure its own position by using the latest initialization process all the time and to improve the matching accuracy.

First, information on the initial direction is acquired at step 2001. This information on the initial direction includes the two different kinds of image information to be described as follows: the strip-shaped image 1005 in the direction perpendicular to the optical axis of the camera, which constitutes the imaging area in this embodiment, and the range image taken in the same position as this image 1005.

The information on the initial direction uses as markers any desired pattern contained in the omni-directional camera images 1005. A case in which the three marker objects 1000, 1002 and 1003 are arranged in random positions around the wide-angle camera 1000 as shown in FIG. 1 is taken up as an example to refer to in the following description. In this case, strip-shaped area 1004 cut out of the sensed image would look like 1005. In this image 1005, the vertical axis represents the optical axis in the coordinate system around the camera, namely the z-axis, and the horizontal axis, the rotation angle θ around the z-axis. There is no particular need to install the markers 1001 through 1003 in this case, but indoor scenes sensed by the camera 1000 would serve the purpose.

Further, range images matching on a one-to-one basis all the pixels contained in the strip-shaped part 1004 are acquired. A range image refers to an image in which the values of distances from the center of the camera 1000 to indoor structures (including walls and furniture) corresponding to the pixels are registered in constituent pixels of the image. A suitable method for photographing such range images uses laser radar.

At step 2002, variations in the image due to the moving of the camera's own position are calculated. This calculation can be accomplished by applying, for instance, Formula 2001 to the strip-shaped part 1004.

$${θ}_{1} = {tan}^{- 1} \frac{r sin θ - {y}_{1}}{r cos θ - {x}_{1}} \qquad [ Formula 2001 ]$$

Formula 2001 represents a varied direction θ1 of an indoor object point, of which the position is (x, y) and the moving direction is θ, in a case in which a camera, whose initial position is (0, 0), has moved by a moving vector (x, y) from its initial position, and the position of the indoor object point has moved from its own position sensed in the omni-directional camera images taken by the camera in its initial position. In Formula 2001, r represents the value of distance matching the indoor object point registered in the range image sensed by the camera in its initial position (0, 0). Formula 2001 has to satisfy the conditions of Formulas 2002.
r cos θ−x₁>0,r sin θ−y₁≧0: θ₁=θ₁
r cos θ−x₁<0: θ₁=π+θ₁
r cos θ−x₁>0,r sin θ−y₁<0: θ₁=2π+θ₁ [Formulas 2002]

Formula 2001 allows a prediction of the position in the image to which each pixel contained in the strip-shaped part 1004 moves as the camera's own position moves. By moving pixels to their respective predicted positions and drawing a picture, the predicted image after the movement can be synthesized. Incidentally, so that unevenness in density may not arise in the arrangement of pixels in the synthesized predicted image as a result of predictive calculation, it is preferable to apply interpolation as appropriate.

At step 2003, the synthetic image after the predictive calculation, created with respect to the range in which the robot can travel, is correlated with the camera's own position and saved in a list of predicted images. While the total number of lists of predicted images is determined by the number of divisions of the range in which the robot can travel, it is preferable for this number of divisions to be set to a level of grain fineness that would allow reproduction of the traveling track of the robot.

Next at step 2004, the camera position is actually moved, and omni-directional camera images as viewed from the position to which it has been moved are sensed. At step 2005, the omni-directional camera images sensed at the preceding step are matched with the synthetic images after the predictive calculation stored into the list of predicted images at step 2003. The matching is accomplished by calculating the degree of agreement between the predicted image and the omni-directional camera images while shifting them in the horizontal (θ) direction; matching is deemed to have succeeded when the degree of agreement reaches its maximum. If as a result the omni-directional camera images sensed at step 2004 and the synthetic image after the predictive calculation are successfully matched with a certain degree of deviation in the horizontal (θ) direction, this degree of deviation matches the angle of posture to the initial posture of the robot. Then at step 2006, the position corresponding to the predictive direction and posture in which matching was successful are outputted. Then the robot can detect its posture, which is a direction around z-axis. In a mode of implementing steps 2001 through 2006 described above, if steps 2001 through 2003 are implemented only once at the beginning as the initialization process as shown in FIG. 2 and, when the robot (camera) moves its own position, the self-locating process of steps 2004 through 2006 is repeated, the volume of calculation at the time of movement can be reduced. Alternatively, step 2001 can be implemented once at the beginning as the initialization process, followed by repetition of steps 2002 through 2006. In this way, it will be sufficient to deliver only the information on the initial direction to the self-locating process, resulting in a reduction in the quantity of information that has to be delivered.

Further, where the initial position to be used in the initialization process flow is given in absolute coordinates, the moved position can be outputted in absolute coordinates by adding the camera's own position outputted at step 2006 as a position relative to the initial position and the initial absolute coordinates vectorally.

An advantage of the method of self-locating by matching the predicted image with the sensed image after movement consists in that, even if any specific marker provided for use in self-locating cannot be identified, no failure is likely to occur in subsequent processes. Possible cases of failing to identify a specific marker include, for instance, a failure to detect a prescribed marker as a consequence of variation in lighting conditions in the course of the self-locating process and the invasion of a moving obstacle into the field of view of the camera to prevent a marker specified in advance from being detected. Even in any such case, if any characteristic pattern contained in the predicted image can be substituted for the marker, self-locating will not fail, making this procedure a robust self-locating method.

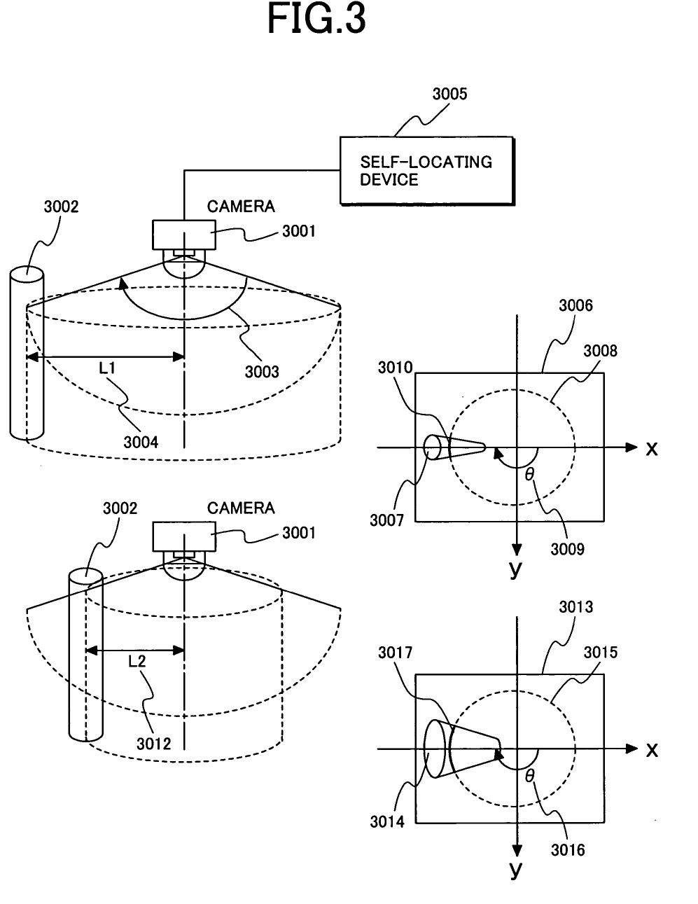

FIG. 3 shows the configuration of a self-locating device, according to an aspect of the present invention. This embodiment is a device, which enables a camera to recognize its own position and posture by recognizing markers that are installed. By using this embodiment instead of implementing step 2001 and step 2004 in FIG. 2, the camera's own position and posture can be determined by simpler calculation. The self-locating device has a configuration in which a camera 3001 having a viewing angle 3003 is linked to a self-locating device 3005. The camera 3001 is equipped with a super-wide angle lens whose viewing angle is 120 degrees or wider. The camera 3001 is installed downward perpendicularly. For the following description, the device position is defined to the position of this camera 3001. In this embodiment, a marker 3002 for use in calculating the device position is installed in a position where the distance 3004 from the axis of view of the camera 3001 is L1. Then, an image sensed by the camera 3001 looks like 3006. The image 3006 includes a reflected image 3007 of the marker 3002. This marker image 3007 is reflected in a position where the rotation angle 3009 around the origin of coordinates written into the image 3006 is θ. A circle centering on the origin of coordinates of this image 3006 is denoted by 3008, and hereinafter this circle will be supposed to be fixed in this position. Of this circle 3008, a (curved) line segment contained in the marker image 3007 is entered into the drawing, denoted by 3010.

Now, as the camera 3001 moves toward the marker 3002 and the distance 3012 between the marker 3002 and the camera 3001 becomes L2, the image 3007 of the marker 3002 reflected in the image 3006 sensed by the camera 3001 is deformed into an image 3014. Then, out of a circle 3015, the (curved) line segment contained in the marker image 3014 is entered into the drawing, denoted by 3017.

Under this condition, the rotation angle 3009 and another rotation angle 3016 correspond to the direction of the marker as viewed from the position of the camera. The lengths of the (curved) line segment 3010 and the (curved) line segment 3017 match the distance of the marker as viewed from the camera position. Therefore, by detecting these (curved) line segments from the image 3006 and an image 3013, the direction and the distance of the marker as viewed from the camera can be detected.

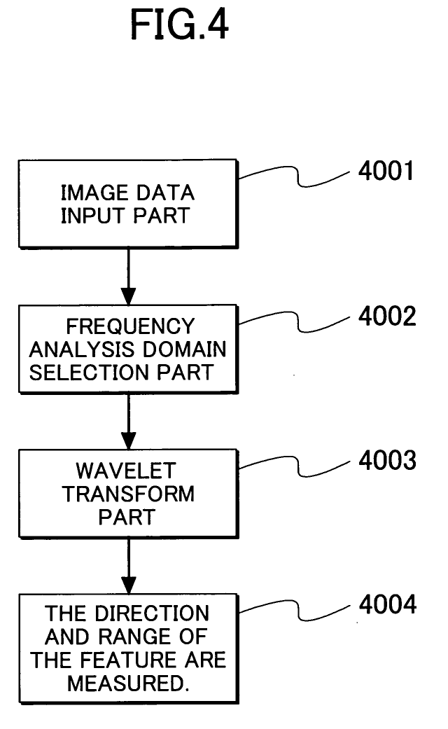

Next, with reference to FIG. 4 through FIG. 7, an embodiment which detects a marker from the position and frequency of a spectral component obtained by subjecting to a wavelet transform the line segments 3010 and 3017 detected from the image contained in the circles 3008 and 3015 in a sensed image will be described.

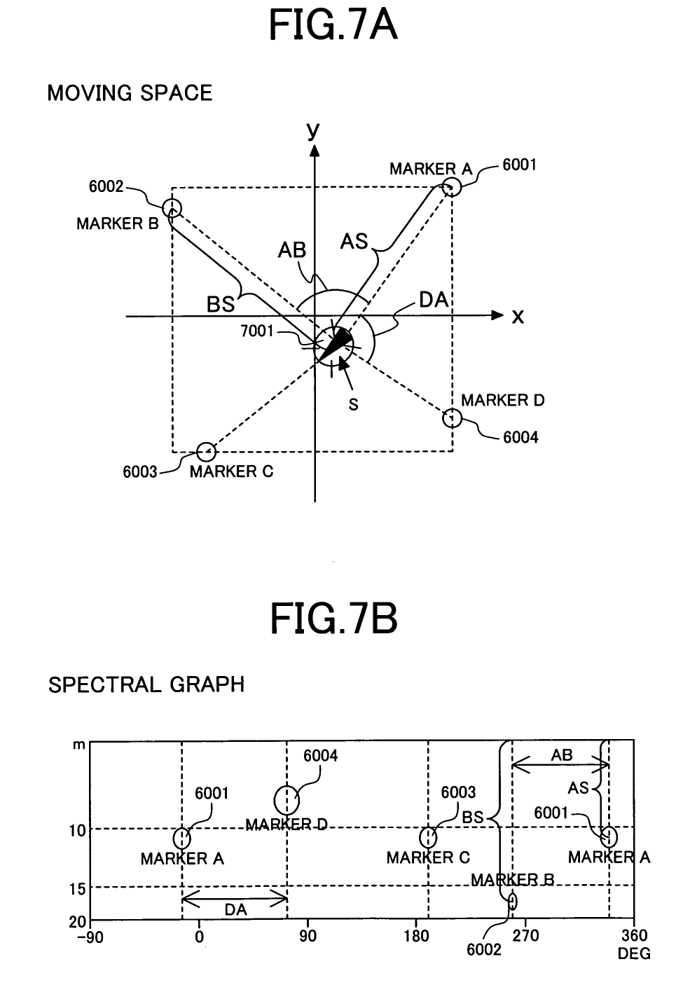

FIG. 4 is a flow chart of processing by the self-locating device 3005. At step 4001, an image data input part captures omni-directional camera images sensed by the camera 3001 into the self-locating device 3005. At step 4002, a frequency analysis domain selection part selects the domain to be subjected to frequency analysis out of the images captured at the preceding step 4001. The domain to undergo frequency analysis is set in a range of 180±60 degrees in viewing angle. In the example shown in FIG. 3, the circle 3008 is selected as the frequency analysis domain. At step 4003, the frequency analysis domain is subjected to wavelet transform by using wavelet transform means to output a two-dimensional spectrum of image space-frequency space. This spectrum can be expressed, for instance, in a spectral graph as shown in FIG. 7B. A direction angle θ corresponding to the dominant component is extracted and used as the feature point of the marker image. Then, a one-dimensional data array corresponding to the θ axis of the spectral graph of FIG. 7B is created; the array in which 1 is stored as the array data corresponding to the feature point of the marker and 0 is stored as all other array data can be deemed to be data of the same form as data resulting from one-dimensional conversion of the omni-directional camera image data sensed at step 2001 or 2004 in FIG. 2.

In this case, range images corresponding to all the images need not be sensed, but it is sufficient to give range data corresponding only to the array data in which 1 is stored correspondingly to the marker position. Then at step 4003, for instance, range data read from the vertical axis of the spectral graph of FIG. 7B can be used instead of range images. θ₁ can be calculated by measuring with the wavelet transform part 4003 the distance r from the camera 3001 to the marker 3002 and substituting it into Formula 2001.

Thus, by using steps 4001 through 4004 in FIG. 4 in place of step 2001 and step 2004 in FIG. 2, the device position and posture can be figured out by simple calculation.

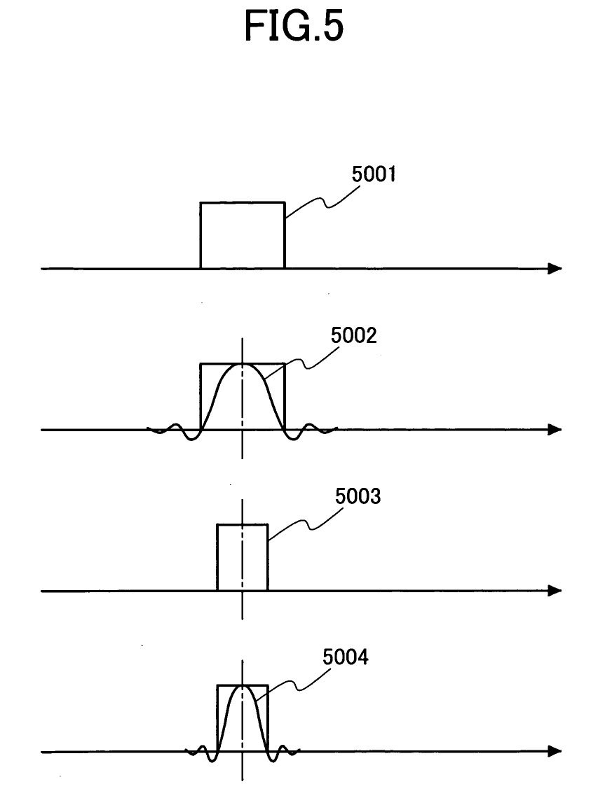

FIG. 5 illustrates the principle of measuring the distance 3012 from the camera 3001 to the marker 3002 with the wavelet transform means 4003. In the following description, it will be assumed that the circle 3015 was selected as the frequency analysis domain in the example of FIG. 3, and image data on the line segment 3017 contained in the marker image 3014 out of the circle 3015 have been detected as a pulse waveform 5001 shown in FIG. 5. If the relationship of correspondence between the fundamental frequency of this pulse waveform 5001 and the distance 3012 between the camera 3001 and the marker 3002 is known, this will enable the distance between the camera 3001 and the marker 3002 to be determined from the frequency of the pulse waveform 5001. For instance, to compare the pulse width of the pulse waveform 5001 and that of a pulse waveform 5003, the latter is narrower. Then, if the result of wavelet transform of the pulse waveform 5001 and the pulse waveform 5003 reveals that a waveform 5002 corresponding to a lower fundamental frequency outputted for the pulse waveform 5001 and a waveform 5004 corresponding to a higher fundamental frequency is outputted for the pulse waveform 5003, this relationship can be matched with the distance from the camera 3001 to the marker 3002. Thus, it is seen that the pulse waveform 5001 is in a position closer than the pulse waveform 5003. If the distance of the pulse waveform 5001 is 1, the distance of the pulse waveform 5003 can be calculated by dividing the fundamental frequency of the waveform 5004 by that of the waveform 5002. In this connection, the relationship between the frequency outputted by the wavelet transform part 4003 and the widths of pulse waveforms will be described hereinbelow.

The wavelet transform part 4003 orthogonally develops the pulse waveform 5001 with, for instance, the localized waveform denoted by 5002 as the orthogonal basis function. In this orthogonal development process, out of the frequency components of the pulse waveform 5001, the high frequency component is developed with an orthogonal basis function with a narrower waveform width and conversely, the low frequency component is developed with an orthogonal basis function with a broader waveform width. And a component for which the waveform width of the orthogonal basis function and width pulse width of the pulse waveform are found identical is the dominant frequency. For instance, where the pulse waveform 5001 is subjected to wavelet transform, a low frequency corresponding to the orthogonal basis function 5002 is dominantly outputted. When the width of the pulse-shaped waveform narrows down to reach that of the pulse waveform 5003, a high frequency corresponding to the orthogonal basis function 5004 is outputted. This characteristic of the wavelet transform part makes it possible to relate the width of the pulse waveform to the dominant frequency, and further to determine the relationship of correspondence between the dominant frequency and the distance.

A supplementary explanation will be given here regarding the principle and formula of wavelet transform calculation.

Methods of measuring the distance between a measurement object and the camera include one by which the distance to the measurement object is measured from variations in the spatial frequency of the pattern (texture) of an object whose dimensions are known. This method is generally applicable because it relates the spatial frequency obtained by direct frequency analysis of image data to the distance to the measurement object and thereby allows the distance to be measured without having to extract an object shape from an image.

It is now supposed that there is a stationary object within the field of view and the spatial frequency of its pattern does not vary as long as it is observed from the same viewpoint. Under this condition, the spatial frequency of an object close to the observer is low, and the spatial frequency rises as the object moves away from the observer.

JP-A No. 281076/1992 discloses a technique by which, in order to make the observation resolution agree with the characteristics of the real world, a variable window-width function defining the window widths of an image space and a frequency space is defined by a function which continuously varies with the frequency is used as the basis function.

In this wavelet transform, the observation resolution of the frequency space is enhanced for the low frequency range by setting the resolution of the image space low and, conversely for the high frequency range, the resolution of the image space is enhanced by setting the resolution of the image space high. This method is applied to a self-locating part that measures the spatial frequency of the pattern of an object whose dimensions are known and measures from variations in the spatial frequency the distance to the object whose dimensions are known. Then, when the object is relatively far, the direction in which it is situated can be observed. As the object approaches the observer, the accuracy of the observation of the distance to the object is improved.

This wavelet transform can be calculated by the following formula, in which the reciprocal 1/a of a scaling factor a represents the aforementioned frequency. In the spectral graph of FIG. 7, 1/a corresponds to the distance on the vertical axis, and the time-lapse b corresponds to the position of the aforementioned localized dominant frequency component. In the spectral graph of FIG. 7, b corresponds to the angle on the horizontal axis.

In the wavelet transform, it is possible to zoom in on the characteristics of any non-stationary signal to make them clearer, and has an advantage over short-time Fourier transform, which is used for the same purpose, that the resolution can be secured in every frequency without being affected by the length of sampling time.

In the consecutive wavelet transform of time series data f(x), (Wψf)(b, a) is defined by Formula 5001.

$$( {W}_{ψ} f ) ( b , a ) = {\int }_{- ∞}^{∞} \overline{ψ ( \frac{x - b}{a} )} f ( x ) ⅆ x \qquad [ Formula 5001 ]$$

In Formula 5001, ψ represents an analyzing wavelet, b the time lapse, and a the scaling factor. Rewriting this Formula 5001 to make the frequency ω a parameter gives Formula 5002.

$$( {W}_{ψ} f ) ( b , a ) = - \frac{1}{2 π} {\int }_{- ∞}^{∞} Ψ ( ω ) F ( ω ) ⅆ ω \qquad [ Formula 5002 ]$$

In the consecutive wavelet transform, the analyzing wavelet ψ is required to satisfy the condition of Formula 5003.

$${\int }_{- ∞}^{∞} ψ ( x ) = 0 \qquad [ Formula 5003 ]$$

In the consecutive wavelet transform, the following Formula 5004 is used as analyzing wavelet ψ, and Formula 5007 is obtained by substituting into the above-cited Formula 5002 Formula 5006 which results from Fourier integration of Formula 5005 wherein ψ is a-scaled and b-translated.

$$\begin{matrix}ψ ( x ) = exp \{ - {( \frac{x}{σ} )}^{2} + ⅈx \} & [ Formula 5004 ] \\ ψ ( x ) = \frac{1}{a} exp \{ - {( \frac{x - b}{a σ} )}^{2} + ⅈ \frac{x - b}{a} \} & [ Formula 5005 ] \\ Ψ ( ω ) = σ \sqrt{π} exp [ - \{ \frac{{σ}^{2}}{4} {( 1 - ω a )}^{2} + ⅈω b \} ] & [ Formula 5006 ] \\ ( {W}_{ψ} f ) ( b , a ) = - \frac{σ}{2 \sqrt{π}} {\int }_{- ∞}^{∞} exp [ - \{ \frac{{σ}^{2}}{4} {( 1 - ω a )}^{2} + ⅈω b \} ] F ( ω ) ⅆ ω & [ Formula 5007 ]\end{matrix}$$

The technique described above provides the advantage of permitting easy calculation of the distance from omni-directional camera images by matching the dominant component obtained by frequency analysis of the omni-directional camera images with the distance. Also, since it is applied to non-periodic localized waveforms, it is expected to prove more effective for the invention disclosed in the present application than ordinary Fourier transform, which tends to even the spectrum to be observed on an overall basis (over the whole space to be analyzed). Furthermore, it serves to solve the problem with the short-time Fourier transform that the fixed resolutions of the image space and the frequency space are inconsistent with the characteristics of the real world.

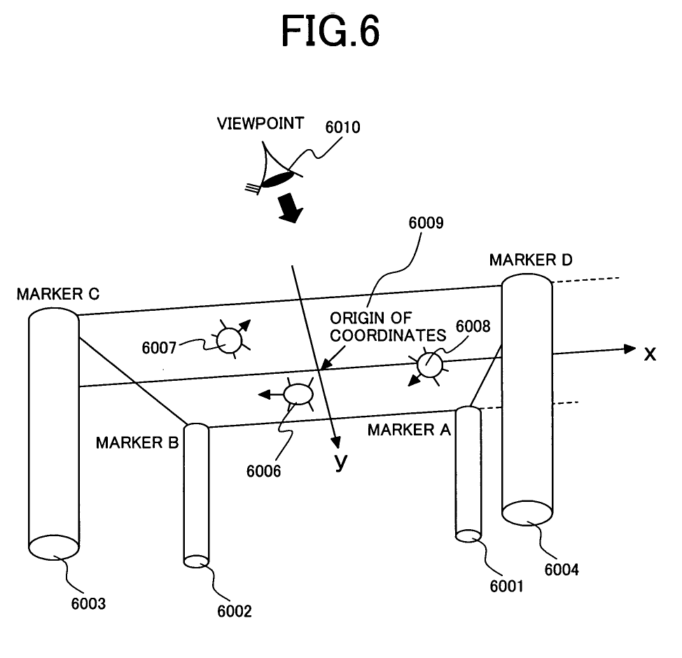

FIG. 6 illustrates a case of applying the self-locating device to ceiling-walking robots 6006 through 6008. In the four corners of the walking area of the robots shown in FIG. 6, a marker A 6001, a marker B 6002, a marker C 6003 and a marker D 6004 are installed in asymmetric positions. An x-coordinate system having 6009 as its origin is defined in the robot walking area. When viewed from a viewpoint 6010, this x-y coordinate system looks like a right-handed coordinate system. Further in the robot walking area, there are three robots 6006, 6007 and 6008. Each of these robots is fitted with a self-locating device according to the present invention. The axis of view of the camera of the self-locating device is downward perpendicularly.

FIG. 7 shows an overhead view from the viewpoint 6010, with one robot 7001 installed at a coordinate S in the robot walking area. In the x-y coordinate system of FIG. 7, the distance between the robot coordinate S and the marker A 6001 is represented by AS, and that between the robot coordinate S and the marker B6002, by BS. Further, the angle formed between a straight line linking the robot coordinate S and the center coordinate of the marker A 6001 and another straight line linking the robot coordinate S and the center coordinate of the marker B 6002 is represented by AB, and the angle formed between a straight line linking the robot coordinate S and the center coordinate of the marker D 6004 and another straight line linking the robot coordinate S and the center coordinate of the marker A 6001, by DA. The spectral graph of the result of a frequency analysis performed of a frequency analysis domain selected out of an image sensed with a camera fitted to the robot 7001 by the method described with reference to FIG. 3 above is shown in FIG. 7B. In this graph, the horizontal axis represents the angle in the local coordinate system centering on the robot coordinate S and the vertical axis, the distance from the robot coordinate S to the marker. Spectra corresponding to the marker A 6001, the marker B 6002, the marker C 6003 and the marker D 6004 are entered into this graph. The relationship of correspondence of the aforementioned distance AS, distance BS, angle AB and angle DA in this spectral graph is also entered. This spectral graph simultaneously reveals the distances from the robot coordinate S to the markers A through D and their directions, and it is thereby possible to measure the device's own position and posture in accordance with flows in FIG. 4 and FIGS. 2A and 2B.

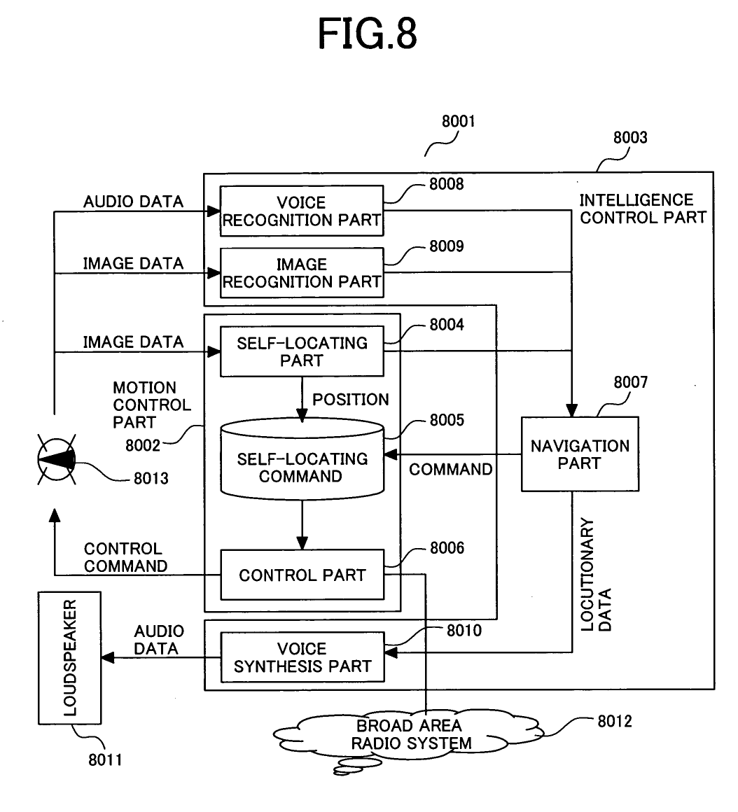

A system configuration further required to architect an autonomous mobile robot by applying the self-locating device, to a ceiling-walking robot will be described with reference to FIG. 8. The system 8001 comprises a self-locating part 8004 similar to 3005 in FIG. 3, a motion control part 8002 containing a control part 8006 for controlling the motions of the robot, and an intelligence control part 8003 responsible for superior control including dialogues with the user. The intelligence control part 8003 comprises a navigation part 8007 for generating control commands for self-regulated movements, a voice recognition part 8008, an image recognition part 8009, and a voice synthesis part 8010. Further, by using a configuration in which the control part 8006 is connected to a broad area ratio system 8012, it is possible to capture broad area information around the robot into the robot.

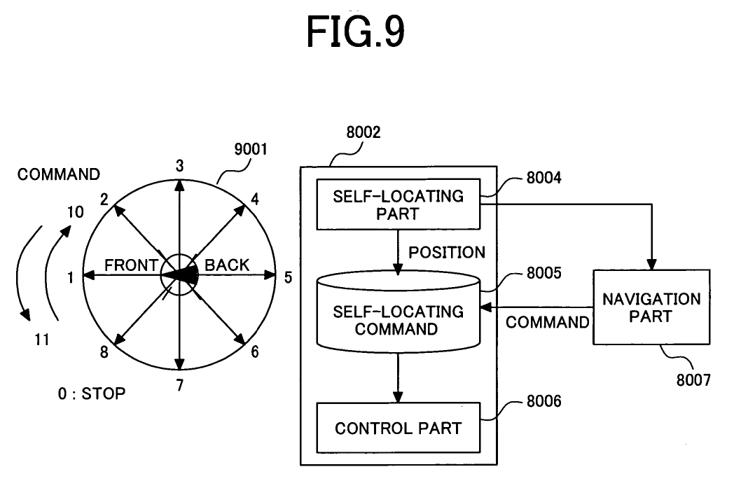

FIG. 9 shows one example of control command transmitted from the navigation part 8007 to the control part 8006. The control command in this example is intended to give an instruction on the moving direction of the robot. The moving direction can be instructed in one of 11 alternatives including, for instance, the eight directions shown along 9001, right turn 10, left turn 11 and stop 0.

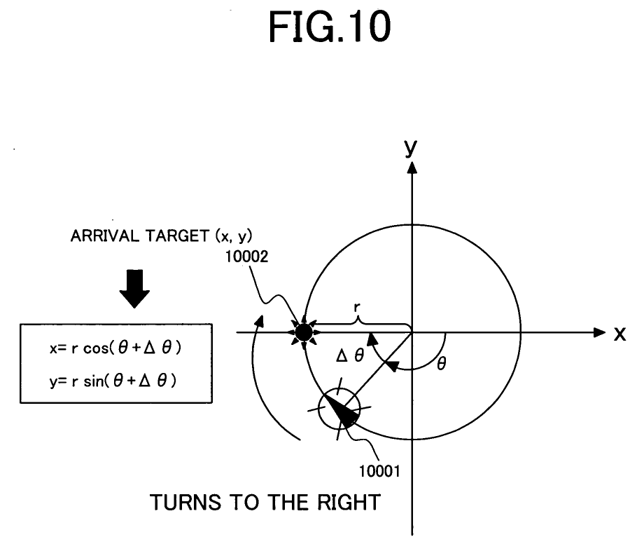

FIG. 10 shows how the robot travels on a circular track under self-regulation. The navigation part 8007 determines a position that is a target of the robot's motion, and keeps on giving control commands needed to make the robot reach this position.

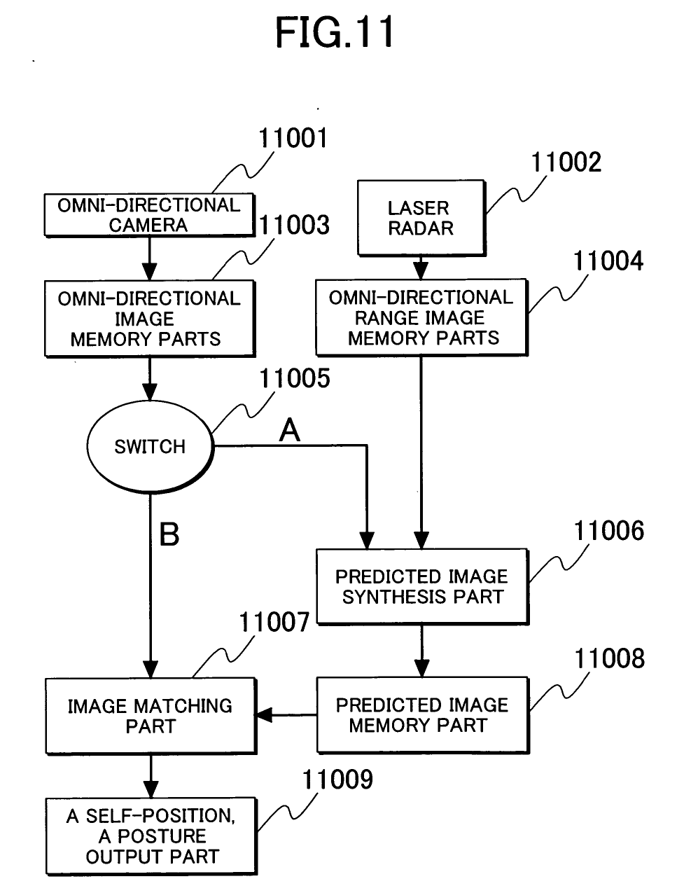

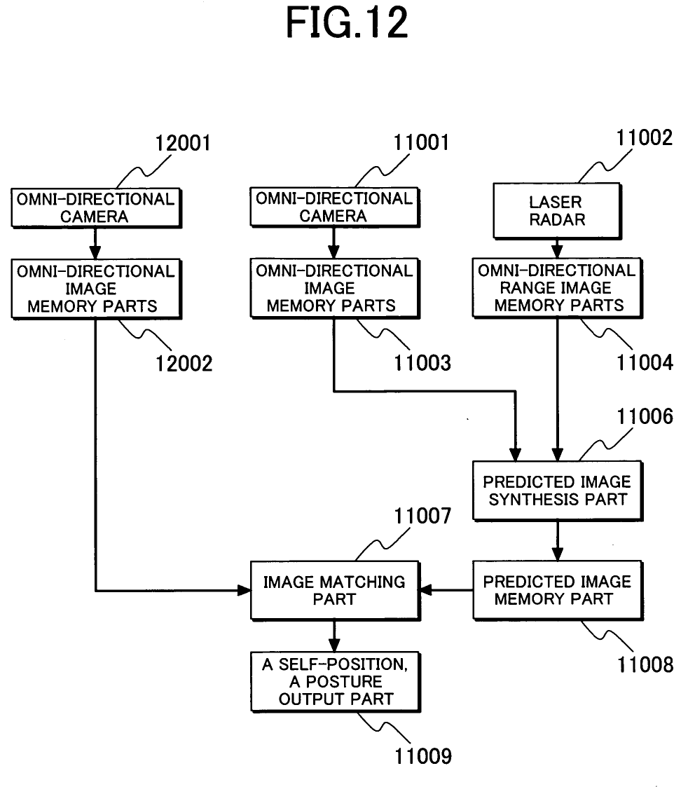

For instance, where the task assigned to the robot is indoor surveillance, usually the robot patrols along a circular track as shown in FIG. 10 in accordance with course information stored in advance, but in the event of finding a suspicious person or the like, the robot will be enabled to start pursuit of this suspicious person. The basic configuration of the self-locating device according to the invention will be described below with reference to FIG. 11 and FIG. 12. FIG. 11 shows the configuration of a case in which an omni-directional camera and a laser radar are installed in their respective initial positions and, after implementing the initialization process flow described with reference to FIG. 2A, the device position is measured while moving only the omni-directional camera. FIG. 12 shows the configuration of a case in which the initialization process flow and the self-locating process flow are implemented, in parallel.

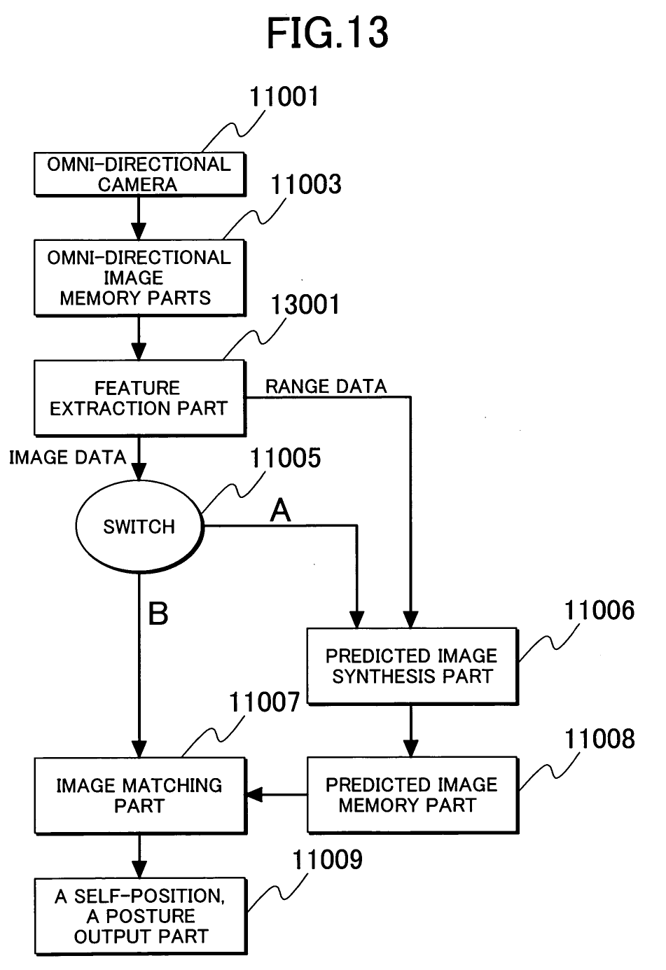

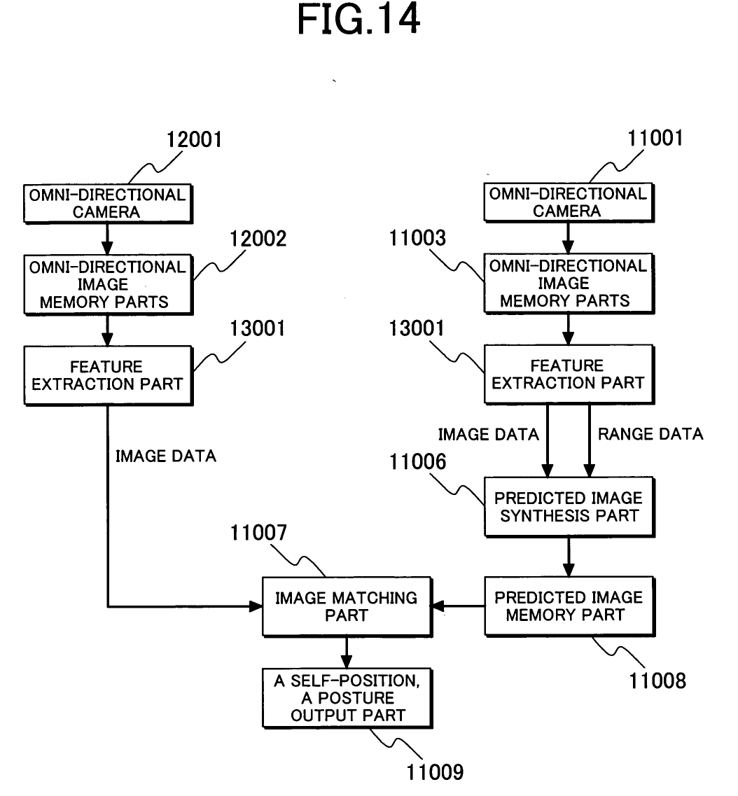

Referring to FIG. 11, signal lines A and B are changed from one to the other with a switch 11005. First, when the initialization process flow is to be implemented, the switch 11005 selects the signal line A. At this time, omni-directional camera images and omni-directional range images sensed with a camera 11001 and laser radar 11002 installed in their respective initial positions are stored into an omni-directional image memory part 11003 and an omni-directional range memory part 11004. A predicted image synthesis part 11006 reads out data stored in the omni-directional image memory part 11003 and the omni-directional range memory part 11004, creates predicted images and stores them into a predicted image memory part 11008. In the following self-locating process flow, the switch 11005 selects the signal line B. Then, omni-directional camera images are sensed while moving only the omni-directional camera 11001, and the contents of the omni-directional image memory part 11003 are updated. The image matching part 11007 matches the omni-directional camera image data stored in the omni-directional image memory part 11003 and the predicted image stored in the predicted image memory part 11008 to calculate the device position and posture, and outputs the results from a self-located position and posture output part 11009. In the configuration shown in FIG. 12, the initialization process flow and the self-locating process flow are executed in parallel making available an omni-directional camera 12001 and an omni-directional camera image memory part 12002 in place of the switch 11005 and having them implement only the self-locating process flow. In the configuration shown in FIG. 12, the omni-directional cameras 12001 and 11001 and the omni-directional camera image memory parts 12002 and 11003 of the same specifications are used. Further, the configurations shown in FIG. 13 and FIG. 14 are simplified by providing a feature extraction part 13001 to implement the process flows of FIG. 2 and thereby dispensing with the laser radar 11002 and the omni-directional range memory part 11004.

The processes disclosed in the application are realized by reading a program into computer. They can as well be realized by coordinated processing by software and hardware.

The self-locating device according to the invention measures a robot position from omni-directional camera images sensed with a camera equipped with a super-wide angle lens, and can be effectively applied to autonomous mobile robots requiring compact and light self-locating devices, and game systems and indoor movement surveillance systems having autonomous mobile robots as their constituent elements.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

What is claimed is:

1. A self-locating device comprising:
an image sensor for acquiring a plurality of sensed images with an omni-directional camera;
a predicted image synthesisor for generating predicted images to be sensed in each of a plurality of arrangement positions via said image sensor;
a recorder for recording said generated predicted images, each of said generated predicted images matched with at least one of the plurality of arrangement positions; and
a self-located position matcher for matching sensed images acquired via said image sensor with said plurality of predicted images to thereby acquire the position and posture of the device.

2. The self-locating device according to claim 1, wherein said self-located position matcher generates said predicted images from images sensed in an initial position and information on the distance to a snapping object in the images.

3. The self-locating device according to claim 1, further cpmprising a feature extractor for selecting a frequency analysis domain out of said plurality of sensed images, subjecting image data in the frequency analysis domain to wavelet transform, and extracting the distances and directions of markers matching the spectral components, wherein said predicted image synthesisor generates said predicted images using said extracted distances and directions.

4. The self-locating device according to claim 3, wherein said markers are arranged in positions assymettrically with respect to the initial position and wherein said markers number at least three.

5. The self-locating device, as set forth in any of claims 1, wherein the device travels on a ceiling.

6. The self-locating device, as set forth in any of claims 2, wherein the device travels on a ceiling.

7. The self-locating device, as set forth in any of claims 3, wherein the device travels on a ceiling.

8. A program for executing a self-locating method to be executed in information processing connected to a mobile body having an image sensor, said self-locating method comprising:
acquiring a plurality of sensed images using an omni-directional camera attached to the mobile body;
generating a plurality of predicted images expected to be sensed by said mobile body in positions to which said mobile body may move;
storing into a recording part the images matched with the positions to which said mobile body may move; and
matching said plurality of sensed images and said plurality of predicted images to determine the position and posture of the mobile body.

9. The program according to claim 8, wherein said plurality of predicted images are generated from images sensed in an initial position and information on the distance to the sensed object in the image.

10. The program according to claim 8, wherein said self-locating method further comprises:
sending operation control commands to the mobile body on the basis of said determined position and course information stored in advance.

11. The program according to claim 9, wherein said self-locating method further comprises:
sending operation control commands to the mobile body on the basis of said determined position and course information stored in advance.
